(19) United States
(12) Patent Application Publication
(10) Pub. No.: US 2021/0049345 A1
(43) Pub. Date: Feb. 18, 2021

(54) SYSTEMS AND METHODS FOR AUTOMATING BIOLOGICAL STRUCTURE IDENTIFICATION UTILIZING MACHINE LEARNING

(71) Applicant: Advanced Solutions Life Sciences, LLC, Louisville, KY (US)

(72) Inventors: Jeromy Johnson, Waynesville, OH (US); Rob Eli, Tucson, AZ (US); Jay Hoying, Manchester, NH (US)

(73) Assignee: Advanced Solutions Life Sciences, LLC, Louisville, KY (US)

(21) Appl. No.: 16/993,815

(22) Filed: Aug. 14, 2020

Related U.S. Application Data
(60) Provisional application No. 62/887,244, filed on Aug. 15, 2019.

(51) Int. Cl. G06K 9/00; G06N 20/00; G06T 7/00; G06K 9/62; G06T 5/00

(52) U.S. Cl. CPC G06K 9/00127; G06N 20/00; G06T 2207/20081; G06K 9/6256; G06T 5/003; G06T 7/0012

(57) ABSTRACT

A system for automated biological structure identification using machine learning includes a host device configured to receive an instruction selecting a biological structure to identify, access computer readable media storing multiple machine learning models configured to identify biological structures, select a model among the machine learning models based on the received instruction, receive image data, identify the biological structure, out-of-focus, in the image data using the selected model, send adjustment instructions to an imaging device to adjust focus of the imaging device, receive adjusted image data corresponding to the adjustment instructions, and identify the biological structure, in-focus, in the adjusted image data using the selected model. The host device generates annotations corresponding to the identified biological structure and displays the image data and annotations.

### CROSS-REFERENCE TO RELATED APPLICATIONS

The present application claims the benefit of U.S. Provisional Application No. 62/887,244 filed Aug. 15, 2019, the entirety of which is hereby incorporated by reference.

### TECHNICAL FIELD

The present specification generally relates to systems and methods for identifying biological structures in images, more specifically, systems and methods for automating biological structure identification and collaborative training of machine learning models for biological structure identification.

### BACKGROUND

A common research workflow in the area of medical research is one of interactive inspection of biology through a microscope or other imaging device. This workflow requires a domain expert to iterate through a large number of samples of experiment results and manually interpret the images by visual inspection. This research process is often tedious, slow, and expensive. In addition, different types of biological structures in the samples may require different domain experts to interpret the images.

Accordingly, a need exists for alternative systems and methods for detecting biological structures within a biological sample.

### SUMMARY

In one embodiment, a system for biological structure identification, includes a host device configured to access computer readable media storing multiple machine learning models configured to identify one or more biological structures. The system is configured to receive image data, and receive an instruction selecting a biological structure to identify. The system is configured to select a model among the one or more machine learning models based on the received instruction and identify the biological structure in the image data using the selected model. The system is also configured to generate one or more annotations corresponding to the identified biological structure. The system may also include one or more imaging devices including an imaging component. The imaging device is configured to capture the image data including the biological structure and transmit the image data to the host device.

In another embodiment, the one or more imaging devices further include an actuator configured to change an imaging component setting in response to one or more adjustment instructions received from the host device.

In another embodiment, the host device may be configured to receive the image data from the imaging device, access the computer readable media via a network connection, create a local copy of the selected machine learning model, and send the one or more adjustment instructions to the imaging device based on a communication protocol of the actuator. The host device may be further configured to display the generated annotations and the image data containing the identified biological structure.

In another embodiment, the system further includes an interface device and the host device is configured as a server configured to receive the image data from the interface device via a network, send the one or more adjustment instructions to the interface device, receive the instruction selecting a biological structure from the interface device, select the model from cloud storage storing the model among the one or more machine learning models, and send, via the network, the generated one or more annotations to the interface device.

In yet another embodiment, the host device is further configured to receive, from a first imaging device among the one or more imaging devices, first training image data of the biological structure and receive, from a first interface device, one or more first annotations corresponding to the first training image data, including annotation identifying the biological structure. The host device may be further configured to train a custom machine learning model, using the one or more first annotations and the first training image data, to identify the biological structure and generate one or more annotations corresponding to the biological structure and store the trained custom machine learning model in the computer readable media.

In another embodiment, the host device is further configured to receive, from a second imaging device among the one or more imaging devices, second training image data of the biological structure and receive, from a second interface device, one or more second annotations corresponding to the second training image data, including annotation identifying the biological structure. The training of the custom machine learning model may further include using the one or more second annotations and the second training image data.

In another embodiment, the host device is further configured to receive second training image data, receive one or more second annotations corresponding to the second training image data, including annotation identifying the biological structure, and update the training of the trained custom machine learning model using the one or more second annotations and the second training image data. The host device may be configured to store the updated custom machine learning model in the computer readable media.

In yet another embodiment, the host device is further configured to receive out-of-focus training image data of the biological structure, receive in-focus training image data of the biological structure, and receive one or more annotations corresponding to the out-of-focus training image data and the in-focus training image data, including annotation identifying the biological structure. Using the one or more annotations, the out-of-focus training image data and the in-focus training image data, the host device may be configured to train an autofocus machine learning model to identify the biological structure and generate one or more annotations corresponding to the biological structure. The host device may be configured to store the trained autofocus machine learning model in the computer readable media.

In yet another embodiment, the identifying of the biological structure includes identifying the biological structure, out-of-focus, in the image data using the trained autofocus machine learning model, sending one or more adjustment instructions to the imaging device to adjust one or more imaging component settings of the imaging device, receiving adjusted image data corresponding to the adjustment instructions, and identifying the biological structure, in-focus, in the adjusted image data using the trained autofocus machine learning model.

In yet another embodiment, the imaging component setting comprises one or more of objective, zoom, focus, z-height, or magnification.

In yet other embodiments computer-readable media storing instructions that, when executed by a processor, may cause the processor to perform method steps for automated biological structure identification. The method steps may include receiving out-of-focus training image data of a biological structure, receiving in-focus training image data of the biological structure, receiving one or more annotations corresponding to the out-of-focus training image data and the in-focus training image data, including annotation identifying the biological structure. The methods may further include using the one or more annotations, the out-of-focus training image data, and the in-focus training image data to train an autofocus machine learning model to identify the biological structure and generate one or more annotations corresponding to the biological structure. The methods may include storing the trained autofocus machine learning model in the computer readable media.

The method steps for automated biological structure identification may further include receiving image data, receiving an instruction selecting a biological structure to identify, selecting, based on the received instruction, the autofocus machine learning model among one or more machine learning models configured to identify one or more biological structures, identifying the biological structure, out-of-focus, in the image data using the trained autofocus machine learning model, sending one or more adjustment instructions to the imaging device to adjust one or more imaging component settings of the imaging device, receiving adjusted image data corresponding to the adjustment instructions, identifying the biological structure, in-focus, in the adjusted image data using the trained autofocus machine learning model, and generating one or more annotations corresponding to the identified biological structure.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 illustrates a system for automated detection of biological structures using machine learning according to one or more embodiments shown and described herein;

FIG. 2 illustrates another system for automated detection of biological structures using machine learning according to one or more embodiments shown and described herein;

FIG. 3 illustrates yet another system for automated detection of biological structures using machine learning according to one or more embodiments shown and described herein;

FIG. 4 illustrates a flowchart depicting methods of training a machine learning model, according to one or more embodiments shown and described herein;

FIG. 5 illustrates a flowchart depicting methods of identifying a biological structure using machine learning, according to one or more embodiments shown and described herein;

FIG. 6 illustrates a flowchart depicting methods of identifying a biological structure using an autofocus machine learning model, according to one or more embodiments shown and described herein; and

FIG. 7 illustrates human annotation and machine annotation of an image containing biological structures according to one or more embodiments shown and described herein.

### DETAILED DESCRIPTION

Embodiments of the present disclosure are directed to systems for identifying biological structures, including biomedical objects, in image data. Identification of biological structures may include identifying biomedical structures or biomedical object segmentation. Systems and methods for biomedical object segmentation are described in greater detail in U.S. application Ser. No. 16/832,989 filed Mar. 27, 2020 and entitled Systems and Methods for Biomedical Object Segmentation, which is incorporated herein by reference. Biological structures may include, but are not limited to, any biological constructs such as lab-grown or printed biological tissue constructs. Such biological constructs may be further discussed in U.S. patent application Ser. No. 16/135,299, entitled “Well-Plate and Fluidic Manifold Assemblies and Methods,” filed Sep. 19, 2018, U.S. patent application Ser. No. 15/202,675, filed Jul. 6, 2016, entitled “Vascularized In Vitro Perfusion Devices, Methods of Fabricating, and Applications Thereof,” U.S. patent application Ser. No. 15/726,617, filed Oct. 6, 2017, entitled “System and Method for a Quick-Change Material Turret in a Robotic Fabrication and Assembly Platform,” each of which are hereby incorporated by reference in their entireties.

In particular, the disclosed embodiments are directed to networked systems and methods for collaboratively training artificial intelligence and machine learning models to identify biological structures according to common needs of system users and according to various individual needs of system users. Training images may be produced by different imaging devices in different locations, from different biological specimens featuring the same type of biological structure. Annotations for the training images may be provided to the system by different users in different locations through a network. Trained machine learning models may be stored in cloud storage and may be selected and provided to users as needed for identification of one or more biological structures. Identification of biological structures may further include generating annotations for the image data. Annotations may include identification of a location of the identified biological structure, a label for the identified biological structure, a confidence level, scoring, and any other information or metadata related to the image, its source, or the biological structures within it. Scoring may include identification and counting and annotating of each biological structure visible in the image data using trained models 204. The embodiments are described using microscope image data for non-limiting illustration purposes only. However, the principles and procedures disclosed are applicable to a variety of different imaging methods, including, but not limited to, photography, ultrasound, magnetic resonance imaging, X-ray computed tomography, and optical computed tomography. Accordingly, the present disclosure is directed to an intelligent system for identifying biological structures in image data, which may provide faster, more consistent identification and annotation results. These and additional embodiments will be described in greater detail below.

It is also noted that recitations herein of “at least one” component, element, etc., or “one or more” should not be used to create an inference that the alternative use of the articles “a” or “an” should be limited to a single component, element, etc.

It is noted that recitations herein of a component of the present disclosure being “configured” or “programmed” in a particular way, to embody a particular property, or to function in a particular manner, are structural recitations, as opposed to recitations of intended use.

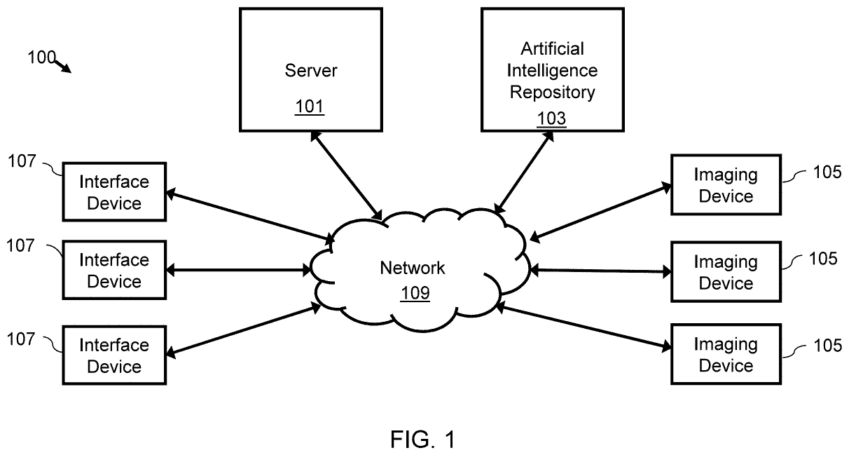

Referring now to FIG. 1, some embodiments of a biological object identification system 100 comprise a server 101, an artificial intelligence repository 103, one or more imaging devices 105 and one or more interface devices 107. The various components of the biological object identification system 100 may communicate with each other through a network 109. The server 101 may comprise a training server, or any computer system, including a virtual server running in a cloud computing environment. The artificial intelligence repository 103 may be stored on local storage of the server 101, or in network storage, including cloud storage. The artificial intelligence repository 103 may include an Application Programming Interface (API) or other communications interface allowing the server, or third parties, to access and retrieve one or more specific machine learning models stored in the artificial intelligence repository 103. Machine learning models may include but are not limited to Neural Networks, Linear Regression, Logistic Regression, Decision Tree, SVM, Naive Bayes, kNN, K-Means, Random Forest, Dimensionality Reduction Algorithms, or Gradient Boosting algorithms, and may employ learning types including but not limited to Supervised Learning, Unsupervised Learning, Reinforcement Learning, Semi-Supervised Learning, Self-Supervised Learning, Multi-Instance Learning, Inductive Learning, Deductive Inference, Transductive Learning, Multi-Task Learning, Active Learning, Online Learning, Transfer Learning, or Ensemble Learning. Machine learning models may include training models or trained models 204. Training models may be generalized machine learning models configured for training based on particular user preferences. The system may be able to retrieve or recall training models 108 to be applied to training image data and annotations in creating a trained model 204. A trained model 204 may comprise a machine learning model trained to identify a particular biological structure. A person of ordinary skill in the art will understand how to provide, train, and use appropriate machine learning models based on principles and concepts disclosed herein.

As will be described in greater detail herein, one or more trained models 204 trained on image data training sets to identify biological structures and generate annotations corresponding to the identified biological structures may be used for intelligent biological structure identification.

With reference to use of “training” or “trained” herein, it should be understood that, in some embodiments, a trained model 204 is trained or configured to be trained and used for data analytics as described herein and training may include collection of training data sets based on images that have been received and annotated by users. As training data sets are provided, the machine learning models may perform biological structure identification more reliably. In some embodiments, certain training models may be specifically formulated and stored based on particular user preferences. For example, a user may be able to recall training models 204 to be applied to new data sets from one or more memory modules, remote servers, or the like. As will be described herein, the systems 100, 200, 300 described herein may be configured to use the one or more trained models 204 to process image data (e.g., unannotated image data or substantially unannotated) of biological constructs and any user preferences (if included) to identify biological structures and generate annotations corresponding to the identified biological structures. As will be explained in greater detail below, automated biological structure identification may include generating annotated image data illustrating locations of the various identified biological structures, analytics regarding the identified biological structures (e.g., types, number, volume, area, etc.). Identified biological structures and corresponding annotations may be displayed to a user.

The imaging devices 105 may comprise a microscope or any imaging device 105 suitable for capturing images of biological structures, including, but not limited to devices configured to generate image data using photography, ultrasound, magnetic resonance imaging, X-ray computed tomography, or optical computed tomography. Imaging devices 105 may be configured to adjust imaging component settings, such as objective, zoom, x and y position, z-height, focus, magnification, or any adjustable imaging device 105 setting that may be suitable for the imaging technology used. The imaging devices 105 may adjust imaging component 105 settings based on adjustment instructions received from one or both of the server 101 and the interface device 107.

Adjustment instructions may be implemented using any computer network protocol including but not limited to USB, FireWire, Serial, eSATA, Wi-Fi, IrDA, Bluetooth, Wireless USB, Z-Wave, ZigBee, and/or other near field communication protocols. A person of ordinary skill in the art will understand how to implement communications between a computer and a peripheral device, such as an imaging device, to accomplish adjustment of imaging component 105 settings according to the particular imaging technology being used. Imaging devices capable of interfacing with a computer system to receive adjustment instructions are readily available from commercial suppliers. As a non-limiting example, the IXplore Standard microscope sold by Olympus includes a motorized stage and other motorized components. The Olympus CellSens Standard software is capable of moving the stage of the IXplore Standard microscope in order to capture images. Similar software for annotating images and controlling imaging components of an imaging device is also available from Nikon, Leitz, Zeiss, and others. A person of ordinary skill in the art is capable of selecting an imaging device with the appropriate actuators, or implementing an imaging device with actuators according to the requirements of the disclosed embodiments.

According to some embodiments, the one or more interface devices 107 may be configured to display image data to a user, receive annotations corresponding to the image data from the user, train a machine learning model using the annotations and image data, and send the trained machine learning model to the server 101 for storage in the artificial intelligence repository 103. According to some embodiments, the interface devices 107 may comprise any computing device with or without human interface devices such as a display or keyboard. Some non-limiting examples of interface devices 107 include laptops, desktops, smartphone devices, tablets, PCs, or the like. According to some embodiments, interface devices 107 may also include computing devices comprising a processor, memory, and a network communication device which are configured to receive instructions or communications from another interface device 107 or a server 101, receive image data from one or more imaging devices 105, and send adjustment instructions to one or more imaging devices 105. The ability to display image data and receive annotations is widely available through both proprietary and open-source software. A person of ordinary skill in the art will be capable of acquiring or implementing image annotation software that meets the needs of the disclosed embodiments.

In the disclosed embodiments, the network 109 may include one or more computer networks (e.g., a personal area network, a local area network, grid computing network, wide area network, etc.), cellular networks, satellite networks, the internet, a virtual network in a cloud computing environment, and/or any combinations thereof. Accordingly, the server 101, artificial intelligence repository 103, one or more imaging devices 105, and one or more interface devices 107 can be communicatively coupled to the network 109 via a wide area network, via a local area network, via a personal area network, via a cellular network, via a satellite network, via a cloud network, or the like. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB, Serial ATA, eSATA, and FireWire. Suitable cellular networks include, but are not limited to, technologies such as LTE, WiMAX, UMTS, CDMA, and GSM. Accordingly, the network 109 can be utilized as a wireless access point by the system 100, 200, 300 to access one or more servers 109.

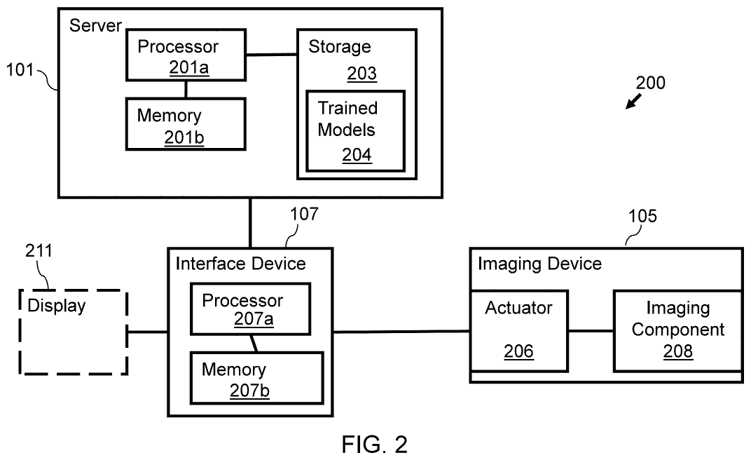

Referring now to FIG. 2, according to an embodiment, the interface device 107 may operate as a host device configured to communicate with an imaging device 105 and a server 101 via a network 109 (not illustrated in FIG. 2) to accomplish training a machine learning model and using a trained model to identify biological structures. The imaging device 105 may comprise an actuator 206 and an imaging component 208. The imaging device 105 is configured to capture an image using one or more imaging components 208 and send the captured image to the interface device 107.

The imaging component 208 may comprise any component that captures an image or affects the image that is captured. As a non-limiting example, a microscope may include an imaging component 208 comprising a lens and the position of the lens may affect the focus or zoom of the captured image even if the lens does not ultimately capture the image. A microscope may also include an imaging component 208 comprising an image sensor, a CCD sensor, or another optical capture device, and settings of the image sensor or other optical capture device may affect the color, contrast, noise, or other characteristics of the captured image.

The actuator 206 may be configured to receive adjustment instructions from the interface device 107 and adjust one or more settings of the imaging component 208. In one non-limiting example, the imaging device 105 comprises a microscope, the imaging component 208 may comprise a lens, and the actuator 206 may comprise a stepper motor. The stepper motor may physically move the lens of the microscope in order to adjust focus, zoom, or to position the lens relative to a specimen placed on a stage of the microscope. Alternatively, the imaging component 208 may comprise the microscope stage, and the stepper motor actuator 206 may move the microscope stage relative to the lens in order to affect the captured image. Depending on the imaging technology used, the actuator may adjust the one or more imaging component 208 settings physically, electronically, or programmatically by adjusting software-based image processing settings. Based on the principles and concepts disclosed herein, a person of ordinary skill in the art would understand what type of actuator is appropriate for adjusting a particular setting of the imaging component 208 that has an effect on the captured image.

According to some embodiments, the interface device 107 may comprise a personal computer, tablet computer, or mobile computing device comprising a processor 207a and memory 207b. The memory 207b of the interface device 107 may store computer instructions that, when executed by the processor 207a, cause the interface device 107 to perform functions related to communication and interaction with the sever 101, the imaging device 105, and a user. The interface device 107 may optionally include a display 211, on which the interface device 107 displays the image data received from the imaging device 105, annotations related to the image data, and a graphical user interface.

According to some embodiments, the interface device 107 is configured to display the image data on the display 211, receive annotations from a user, and train a machine learning model based on the image data and the received annotations. The interface device 107 may send the trained model 204 to the server 101 to be stored in the storage 203.

The interface device 107 may be further configured to receive, from the user, instructions related to identification of a biological structure, receive image data from the imaging device 105, and retrieve a trained model 204 from the server 101. The interface device may create a local copy of the trained model 204. According to some embodiments, the interface device 107 is further configured to use the trained model 204 to identify a biological structure in the image data based on instructions received from the user. Instructions received from the user may comprise one or more user preferences. User preferences may include particular biological structures to be identified using a machine learning model and/or other personalization (e.g., desired outputs, color, labeling, analyzed areas, etc.) for the biological structure detection or display of corresponding annotations.

According to some embodiments, the trained model 204 may comprise an autofocus machine learning model. The autofocus machine learning model may identify the biological structure when out of focus and generate adjustment instructions to bring the biological structure into focus for in-focus identification. The in-focus identification may include a higher confidence level than the out-of-focus identification. The interface device 107 may be further configured to send the adjustment instructions to the imaging device 105 in order to adjust one or more imaging component 208 settings of the imaging device 105, and receive an adjusted image from the imaging device 105. The interface device 107 may also be configured to receive instructions from the user, translate the instructions into adjustment instructions and send the adjustment instructions to the imaging device 105 in order to adjust one or more imaging component 208 settings of the imaging device 105.

The autofocus machine learning model may be configured to autofocus the imaging device 105 for a live feed of image data, generate a live score, and generate annotations. Scoring, including live scoring, may include identification, measurement, counting and annotating of each biological structure visible in the image data using the trained models 204. Live scoring may be performed on the current image data from the imaging device 105, meaning scoring may be performed constantly based on the image data that the imaging device 105 is currently capturing without requiring the image to be saved. The scores and detected biological structures may be displayed in real-time on the display 211, thus giving the user constant feedback on the image currently captured by the imaging device. Scoring may also be performed on single plane of images, as well as on stacked or layered images produced using volumetric projections methods, depending on the application and equipment. The interface device 107 may be configured to save the image data to display, along with annotations and scoring, at a later time. The image data, and associated annotations may be saved either in separate data files or layered into the image data.

The system 100, 200, 300 may be configured to allow the user to issue an instruction to analyze a current sample and the imaging device 105 may detect regions of interest within a sample and then autofocus across all available levels to ensure all objects are detected at the optimal focus level. The value of this capability is that it would eliminate the need for a researcher to sit at the microscope and manually focus or perform other manual microscope-centric tasks.

In an alternative embodiment, the interface device 107 may be configured to receive image data, receive annotations for the image data, and send the image data and annotations to the server in order to train a machine learning model. Multiple interface devices 107 configured in this manner may work together in sending multiple image data and corresponding annotations to the server 101 in order to perform collaborative training of a machine learning model. A collaboratively trained model 204 has the benefit of improved object recognition due to the greater variety of image data from different imaging devices 105 and annotations from different users.

According to some embodiments, when using a trained model 204 to identify a biological structure, the interface device 107 may send, to the server 101, image data and instructions including selection of a biological structure to identify or a specific trained model 204 to be used. The interface device 107 may be configured to receive, from the server 101, annotations generated by the trained model 204, and the interface device 107 may display the image data and the received annotations on the display 211. Some trained models 204 may be computationally intensive for the interface device 107 (e.g., a mobile device), or it may be desirable to free up resources on the interface device 107 for other tasks. Therefore, under some circumstances, it may be desirable for some interface devices 107 to send image data to the server 101 for identification of biological structures.

According to some embodiments, the interface device 107 may be further configured to receive instructions, from the server 101, related to imaging component 208 settings. The interface device 107 may receive the instructions from the server 101 in a common format, and translate into adjustment instructions to be sent to the imaging device 105 based on a communications protocol of the actuator 206.

Accordingly, the interface device 107 may be configured to train a machine learning model and send the trained model 204 to the server 101 for storage. In response to user input, the interface device 107 may retrieve a trained model from the server 101 and use the trained model 204 to identify a biological structure in image data received from the imaging device 105. The interface device 107 may be further configured to send adjustment instructions to the imaging device 105 to change one or more settings of the imaging component 208. The interface device 107 may also be configured to communicate with the server 101 by sending annotations, and image data for training a machine learning model at the server 101 and receive annotations from the server 101.

The server 101 may comprise a processor 201a, memory 201b, and storage 203. The storage 203 may include local storage, networked storage, or cloud storage. One or more trained models 204 may be stored in the storage 203. The memory 201b of the server 101 may store computer instructions that, when executed by the processor 201a, cause the server 101 to perform functions related to communication and interaction with the interface device 107.

According to some embodiments, the server 101 may be configured to receive a trained model 204 from the interface device 107 and store the trained model 204 in the storage 203. The server may also be configured to receive instructions from the interface device 107 and retrieve a trained model 204 based on the received instructions. The instructions received by the server may include a selection of a particular trained model 204 or a biological structure to be identified. The server 101 may retrieve the selected trained model 204 and send it back to the interface device 107. The server 101 may be configured to select an appropriate trained model 204 in response to the received instructions selecting a biological structure to be identified. The server 101 may be configured to use a mapping between biological structures to be identified and a preferred trained model 204 when selecting an appropriate model based on a biological structure to be identified.

According to some embodiments, the server 101 may be configured to receive training image data and annotations from the interface device 107. The server may use the training image data and annotations to train a machine learning model and store the trained model 204 in the storage 203. According to some embodiments, the server may be configured to receive multiple training image data and multiple annotations from multiple interface devices 107. The server 101 may be configured to use the multiple training image data and multiple annotations, received from multiple interface devices 107, to generate a collaboratively trained model 204. Collaboratively trained models 204 may be more robust in their identification of biological structures and generation of annotations because of the variety of training image data from different imaging devices 105 and annotations from different users. Collaboratively trained models may also be trained more quickly because of the increased number of sources of training data that are available from multiple interface devices 107 and multiple imaging devices 105.

According to some embodiments, the server 101 may be configured to receive image data and instructions from the interface device 107, and select a trained model 204 based on the instructions. The server may be further configured to use the selected trained model 204 to identify a biological structure in the image data and generate annotations for the identified biological structure. The server 101 may be configured to send the generated annotations, corresponding to the identified biological structure, to the interface device 107. The server 101 may be configured to use local resources or temporarily allocate resources in a cloud computing environment to run a trained model 204 and generate annotations to be sent back to the interface device 107.

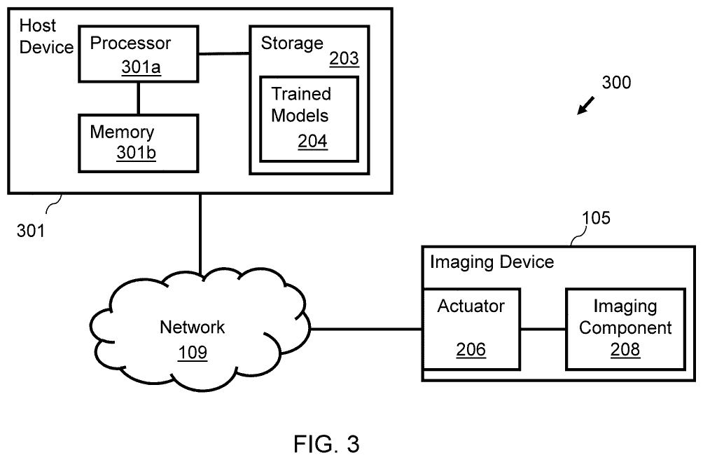

FIG. 3 illustrates yet another system for automated detection of biological structures using machine learning according to one or more embodiments shown and described herein.

Referring now to FIG. 3, the server 101 may be configured as a host device 301 that communicates with the imaging device 105 through a network 109. The network may be a personal area network, a local area network, or a wide area network. According to some embodiments, the memory 301b may store computer readable instructions that, when executed by the processor 301a, cause the host device 301 to communicate with the imaging device 105 and perform functions related to automated detection of biological structures.

The host device 301 may be configured to receive image data produced by the imaging device 105 and send adjustment instructions to the imaging device 105. The imaging device 105 may be configured to, in response to the adjustment instructions, adjust one or more imaging component 208 settings such as objective, zoom, x and y position, z-height, focus, magnification, or any imaging device 105 setting that may be suitable for the imaging technology being used by the imaging device 105. The imaging device 105 may be configured to send adjusted image data back to the host device 301 after one or more adjustments of imaging component 208 settings. Through this process of repeatedly receiving image data, sending adjustment instructions, and receiving adjusted image data, the host device 301 may cause the imaging device 105 to capture image data at every available level of focus of every biological structure that is detectable within a biological sample provided to the imaging device 105. Using principles and concepts disclosed herein, this process of identifying biological structures in a biological sample may be performed without human intervention.

The host device 301 may be further configured to perform object segmentation, 2D volumized projection, 3D volumized projection, or any other image processing functions or methods of producing composite images using one or more trained models 204 or other methods.

According to some embodiments, the actuator 206 is configured to receive adjustment instructions directly from the host device 301. According to other embodiments, an interface device 107 may manage communication between the host device 301 and the imaging device 105, as illustrated and described with reference to FIG. 1 and FIG. 2. According to some embodiments, the interface device 107 may have no display or human interface device, such as a keyboard or mouse, and may be configured to receive image data and adjustment instructions, and translate the image data and adjustment instructions into preferred formats based on configuration settings, such as a communication protocol of the actuator 206.

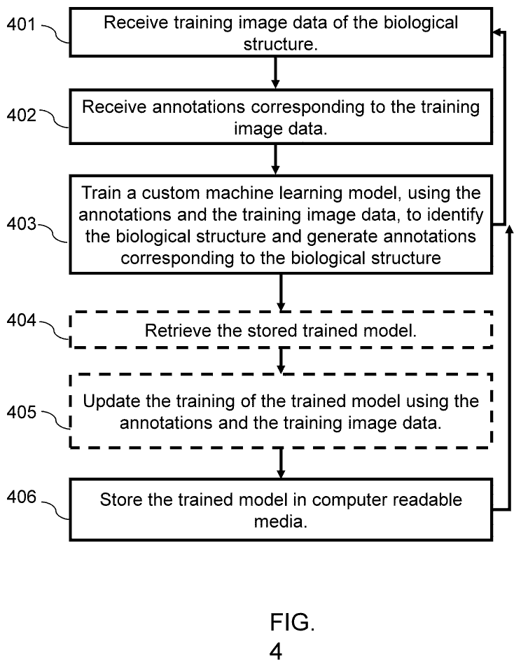

FIG. 4 illustrates a flowchart depicting a method of training a machine learning model, according to one or more embodiments shown and described herein. The methods illustrated in FIGS. 4-6 may be performed by the system comprising any of the server 101, interface device 107, host device 301, or any combination thereof. The method steps may be stored in computer readable media in the form of computer executable instructions and executed by one or more processors of the system 100, 200, 300.

Referring to FIG. 4, at step 401, the system receives training image data of the biological structure. Training image data may be provided by the imaging device 105, or may be previously generated and stored by the interface device 107. Training image data may be any image data of a biological structure that a machine learning model will be trained to identify. Training image data may be generated using any of a variety of known imaging technologies, including, but not limited to, photography, ultrasound, magnetic resonance imaging, X-ray computed tomography, and optical computed tomography. As non-limiting examples, Fujifilm® supplies ultrasonic imaging systems under a product line named VisualSonics™ and Bruker® supplies X-ray computed tomography systems under a product line named SkyScan™. A person of ordinary skill in the art will be aware of many different imaging devices or imaging components that may be integrated into the disclosed embodiments.

At step 402, the system receives annotations corresponding to the training image data. According to some embodiments, the system may be configured to receive training image data or annotations in a standard format used in the industry. These standard formats are known to those of ordinary skill in the art. The system may be further configured to receive annotations and training image data in a proprietary format. The system may be configured to present the training image data to a user, using the display 211 of the interface device 107, and receive annotations from the user.

At step 403, the system trains a custom machine learning model, using the annotations and the training image data, to identify the biological structure and generate annotations corresponding to the biological structure. As an example and not a limitation, the machine learning model may include artificial intelligence components selected from the group consisting of an artificial intelligence engine, Bayesian inference engine, and a decision-making engine, and may have an adaptive learning engine further comprising a neural network, a convolutional neural network (CNN), or a deep neural network-learning engine. It is contemplated and within the scope of this disclosure that the term “deep” with respect to the deep neural network learning engine is a term of art readily understood by one of ordinary skill in the art.

According to some embodiments, the system may continue to receive additional training image data at step 401 and annotations at step 402, and continue to train the custom machine learning model at step 403 using the additional training image data and annotations. The custom machine learning model may be trained using training image data received from one interface device 107 or one imaging device 105, or received from multiple interface devices 107 or multiple imaging devices 105 in a distributed computing environment.

At step 406, the system stores the trained model in computer readable media. The computer readable media may include, but is not limited to, computer memory, local storage, networked storage, or cloud storage. According to some embodiments, after a trained model is stored, the system may optionally continue to receive additional training image data at step 401 and annotations at step 402, retrieve the stored trained model at step 404, and update the training of the trained custom machine learning model at step 405 using the additional training image data and annotations. The updated trained model may be stored in the computer readable media at step 406.

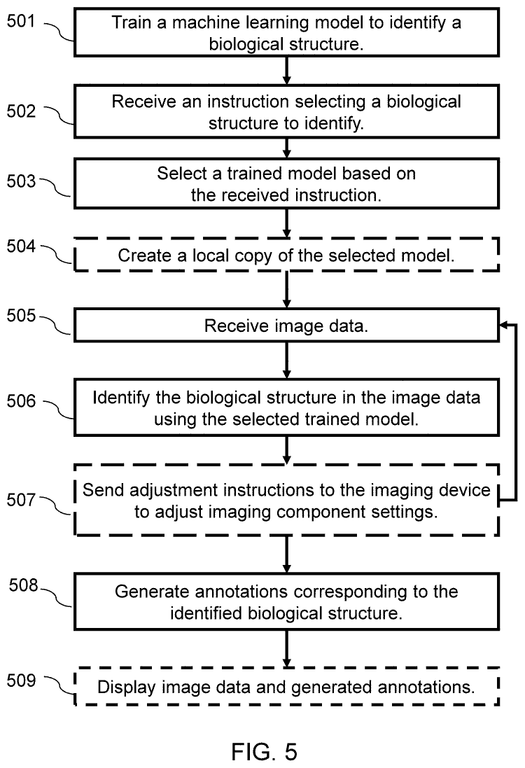

FIG. 5 illustrates a flowchart depicting a method of identifying a biological structure using a trained machine learning model, according to one or more embodiments shown and described herein. At step 501, the system trains a machine learning model to identify one or more biological structures. The training may be performed according to any of the embodiments disclosed herein.

At step 502, the system receives an instruction selecting a biological structure to identify. At step 503, the system selects a trained model based on the received instruction. The instruction of step 502 may include a selection of a particular trained model 204 or a biological structure to be identified. The system may retrieve the selected trained model 204 identified in the instruction of step 502 or select an appropriate trained model 204 based on a mapping between biological structures to be identified and a preferred trained model 204.

At step 504, the system may create a local copy of the selected model. According to some embodiments, the system may create a local copy of the trained model 204 and use the trained model 204 to identify a biological structure in the image data based on instructions received from a user.

At step 505, the system receives image data from an imaging device 105. At step 506, the system identifies the selected biological structure in the image data using the selected machine learning model. At step 507, the system may optionally send adjustment instructions to the imaging device 105 to adjust one or more imaging component 208 settings and return to step 505 to receive additional image data. The system may repeatedly receive image data at step 505, and send adjustment instructions at step 506 to cause the imaging device 105 to capture image data at every available level of focus for every biological structure that is identifiable by the one or more machine learning models within a biological sample provided to the imaging device 105. The adjustment instructions may cause the imaging device 105 to move the biological sample, panning, zooming and changing focus in order to generate image data suitable for identifying one or more biological structures in the biological sample.

At step 508, the system generates annotations corresponding to the identified biological structure. The annotations generated may include an identification of the biological structure. The annotations may also include a confidence level or any other information or metadata related to the image, its source, or the biological structures represented in the image data. Any number or type of annotations may be generated, and the annotations generated may be dependent on what annotations were provided to the system during training of the trained model 204. At step 509, the system optionally displays the image data and generated annotations.

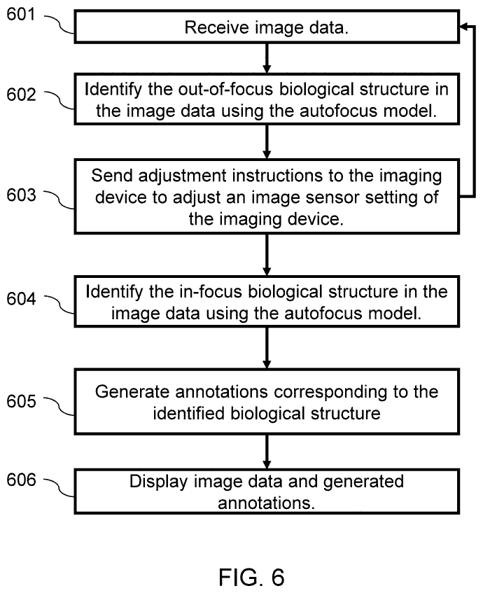

FIG. 6 illustrates a flowchart depicting a method of identifying a biological structure using an autofocus model from among the trained models 204, according to one or more embodiments shown and described herein. The system may perform autofocus in response to selecting a trained model 204 that has been trained to detect biological structures out of focus and generate autofocus adjustment instructions to be sent to the imaging device 105. At step 601, the system receives image data. Image data may be received according to any of the embodiments disclosed herein.

At step 602, the system identifies the out-of-focus biological structure in the image data using the autofocus model. Based on the out-of-focus biological structure identified in the image data, the system may generate adjustment instructions designed to bring the out-of-focus biological structure into focus. At step 603, the system sends the adjustment instructions to the imaging device 105 to adjust an image sensor setting (e.g., focus level) of the imaging device 105. The system may then return to step 601 to receive adjusted image data in response to the adjustment instructions sent to the imaging device 105. At step 603, the system identifies the in-focus biological structure in the image data using the autofocus model. The system may generate annotations in step 605 and display the image data and generated annotations in step 606 according to any of the embodiments disclosed herein.

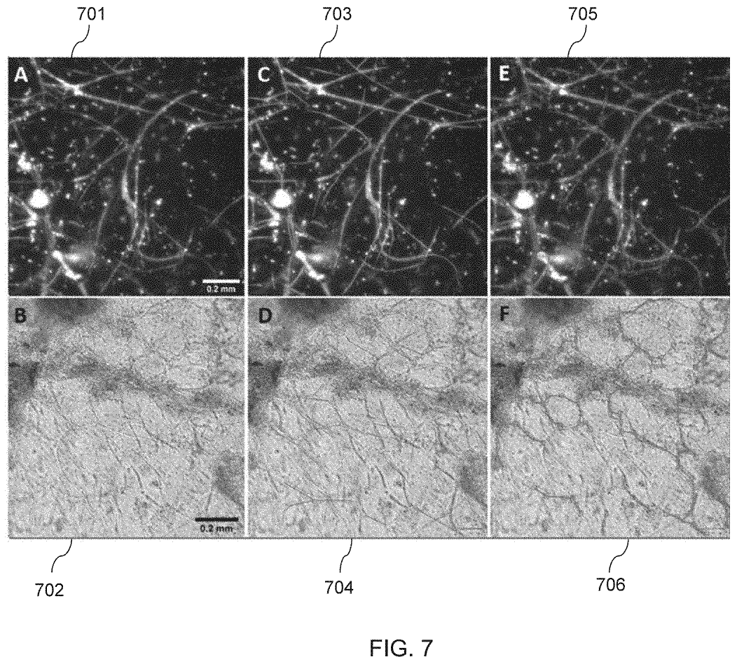

FIG. 7 illustrates human annotation and machine annotation of an image containing biological structures according to one or more embodiments shown and described herein.

Referring now to FIG. 7, two images 701, 702 are shown containing biological structures: a Fluorescent image 701 (panel A) and a phase contrast image 702 (panel B) taken at a 10× magnification. Annotations are manually added to the images 701, 702 to mark vessels. The annotated images 703, 704 may be used for training a machine learning model according to the disclosed embodiments. After training, the trained model 204 may be used to identify vessels and calculate vessel pixel length. The machine annotated fluorescent image 705 and machine annotated phase contrast image 706 illustrate the display of image data with annotations included. FIG. 7 is not meant to be exhaustive of all methods of annotating an image. Any annotations may be used and the machine learning models of the disclosed embodiments may be trained using image data annotated in any manner.

In should now be understood that embodiments as described herein are directed to identifying biomedical structures, also known as biomedical object segmentation, within biological constructs from image data. In some embodiments, such identification may occur in real-time as changes occur to the biological construct. As noted above, identifying biomedical structures within a biological constructs may be difficult and time-consuming. Additionally, identification must generally be performed by highly trained individuals. Absence of such highly trained individuals may make it difficult to perform biomedical object segmentation. Moreover, biomedical object segmentation may be subject to human biases and errors, which could lead to inconsistent analyses/detection of biological structures within image data. Accordingly, the present disclosure is directed to an intelligent system for performing biological structure identification from image data of a biological construct, which may provide faster, more consistent identification results

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for biological structure identification, the system comprising:
a host device configured to:
access computer readable media storing multiple machine learning models configured to identify one or more biological structures;
receive image data;
receive an instruction selecting a biological structure to identify;
select a model among the one or more machine learning models based on the received instruction;
identify the biological structure in the image data using the selected model; and
generate one or more annotations corresponding to the identified biological structure;
one or more imaging devices comprising an imaging component, the imaging device configured to:
capture the image data including the biological structure; and
transmit the image data to the host device.

2. The system of claim 1, wherein the one or more imaging devices further comprise an actuator configured to:
change an imaging component setting in response to one or more adjustment instructions received from the host device.

3. The system of claim 2, wherein the host device comprises an interface device configured to:
receive the image data from the imaging device;
access the computer readable media via a network connection;
create a local copy of the selected machine learning model;
display the generated annotations and the image data containing the identified biological structure; and
send the one or more adjustment instructions to the imaging device based on a communication protocol of the actuator.

4. The system of claim 2, further comprising an interface device, wherein the host device comprises a server configured to:
receive the image data from the interface device via a network;
send the one or more adjustment instructions to the interface device;
receive the instruction selecting a biological structure from the interface device;
select the model from cloud storage storing the model among the one or more machine learning models; and
send, via the network, the generated one or more annotations to the interface device.

5. The system of claim 1, wherein the host device is further configured to:
receive, from a first imaging device among the one or more imaging devices, first training image data of the biological structure;
receive, from a first interface device, one or more first annotations corresponding to the first training image data, including annotation identifying the biological structure;
train a custom machine learning model, using the one or more first annotations and the first training image data, to identify the biological structure and generate one or more annotations corresponding to the biological structure; and
store the trained custom machine learning model in the computer readable media.

6. The system of claim 5, wherein the host device is further configured to:
receive, from a second imaging device among the one or more imaging devices, second training image data of the biological structure;
receive, from a second interface device, one or more second annotations corresponding to the second training image data, including annotation identifying the biological structure;
wherein the training of the custom machine learning model comprises using the one or more second annotations and the second training image data.

7. The system of claim 5, wherein the host device is further configured to:
receive second training image data;
receive one or more second annotations corresponding to the second training image data, including annotation identifying the biological structure;
update the training of the trained custom machine learning model using the one or more second annotations and the second training image data;
store the updated custom machine learning model in the computer readable media.

8. The system of claim 1, wherein the host device is further configured to:
receive out-of-focus training image data of the biological structure;
receive in-focus training image data of the biological structure;
receive one or more annotations corresponding to the out-of-focus training image data and the in-focus training image data, including annotation identifying the biological structure;
using the one or more annotations, the out-of-focus training image data and the in-focus training image data, train an autofocus machine learning model to identify the biological structure and generate one or more annotations corresponding to the biological structure;
store the trained autofocus machine learning model in the computer readable media.

9. The system of claim 8, wherein the identifying of the biological structure comprises:
identifying the biological structure, out-of-focus, in the image data using the trained autofocus machine learning model;
sending one or more adjustment instructions to the imaging device to adjust one or more imaging component settings of the imaging device;
receiving adjusted image data corresponding to the adjustment instructions; and
identifying the biological structure, in-focus, in the adjusted image data using the trained autofocus machine learning model.

10. The system of claim 1, wherein the imaging component setting comprises one or more of objective, zoom, focus, z-height, or magnification.

11. A method for automatically identifying biological structures using machine learning, the method comprising:
receiving image data;
receiving an instruction selecting a biological structure to identify;
selecting, based on the received instruction, a machine learning model among one or more machine learning models configured, respectively, to identify one or more biological structures;
identifying the biological structure in the image data using the selected model; and
generating one or more annotations corresponding to the identified biological structure.

12. The method of claim 11, further comprising:
receiving, from a first imaging device, first training image data of the biological structure;
receiving, from a first interface device, one or more first annotations corresponding to the first training image data, including annotation identifying the biological structure;
training a custom machine learning model, using the one or more first annotations and the first training image data, to identify the biological structure and generate one or more annotations corresponding to the biological structure; and
storing the trained custom machine learning model in a computer readable medium.

13. The method of claim 12, further comprising:
receiving, from a second imaging device, second training image data of the biological structure;
receiving, from a second interface device, one or more second annotations corresponding to the second training image data, including annotation identifying the biological structure;
wherein the training of the custom machine learning model comprises using the one or more second annotations and the second training image data.

14. The method of claim 12, wherein the host device is further configured to:
receiving second training image data;
receiving one or more second annotations corresponding to the second training image data, including annotation identifying the biological structure;
updating the training of the trained custom machine learning model using the one or more second annotations and the second training image data;
storing the updated custom machine learning model in the computer readable media.

15. The method of claim 11, further comprising:
receiving out-of-focus training image data of the biological structure;
receiving in-focus training image data of the biological structure;
receiving one or more annotations corresponding to the out-of-focus training image data and the in-focus training image data, including annotation identifying the biological structure;
using the one or more annotations, the out-of-focus training image data and the in-focus training image data, training an autofocus machine learning model to identify the biological structure and generate one or more annotations corresponding to the biological structure;
storing the trained autofocus machine learning model in the computer readable media.

16. The method of claim 15, further comprising:
identifying the biological structure, out-of-focus, in the image data using the trained autofocus machine learning model;
sending one or more adjustment instructions to the imaging device to adjust one or more imaging component settings of the imaging device;
receiving adjusted image data corresponding to the adjustment instructions; and
identifying the biological structure, in-focus, in the adjusted image data using the trained autofocus machine learning model.

17. The method of claim 11, further comprising:
creating a local copy of the selected machine learning model.

18. The method of claim 11, further comprising:
displaying the generated annotations and the image data containing the identified biological structure.

19. A computer-readable medium storing instructions that, when executed by a processor, cause the processor to perform steps comprising:
receiving out-of-focus training image data of a biological structure;
receiving in-focus training image data of the biological structure;
receiving one or more annotations corresponding to the out-of-focus training image data and the in-focus training image data, including annotation identifying the biological structure;
using the one or more annotations, the out-of-focus training image data and the in-focus training image data, training an autofocus machine learning model to identify the biological structure and generate one or more annotations corresponding to the biological structure;
storing the trained autofocus machine learning model in the computer readable media.

20. The computer-readable medium storing further instructions that, when executed by a processor, cause the processor to further perform steps comprising:
receiving image data;
receiving an instruction selecting a biological structure to identify;
selecting, based on the received instruction, the autofocus machine learning model among one or more machine learning models configured to identify one or more biological structures;
identifying the biological structure, out-of-focus, in the image data using the trained autofocus machine learning model;
sending one or more adjustment instructions to the imaging device to adjust one or more imaging component settings of the imaging device;
receiving adjusted image data corresponding to the adjustment instructions;
identifying the biological structure, in-focus, in the adjusted image data using the trained autofocus machine learning model; and
generating one or more annotations corresponding to the identified biological structure.
